(19) United States
(12) Patent Application Publication
(10) Pub. No.: US 2003/0144030 A1
(43) Pub. Date: Jul. 31, 2003

(54) Method and apparatus for communicating over a wireless communications network

(76) Inventor: Jordan Adam Newmark, Fort Lauderdale, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/352,682

(22) Filed: Jan. 28, 2003

Related U.S. Application Data
(60) Provisional application No. 60/352,536, filed on Jan. 29, 2002.

(51) Int. Cl. H04B 1/38; H04Q 7/20

(52) U.S. Cl. 455/557; 455/517

(57) ABSTRACT

A method for communicating over a wireless communications network is disclosed, the method comprising the steps of providing a docking port of a base member for a wireless communication device; linking the wireless communication device to a communications system of the base member; engaging a base unit of the communications system to perform a function; converting the function into output data; transmitting the output data to the communications system; routing the output data from the communications system to the wireless communication device; and communicating the output data from the wireless communication device to the wireless communications network.

### CROSS-REFERENCES TO RELATED APPLICATIONS

This application claims the benefit of U.S. Provisional Application Serial No. 60/352,536, filed on Jan. 29, 2002, entitled METHOD AND APPARATUS FOR COMMUNICATING OVER A WIRELESS COMMUNICATIONS NETWORK.

### TECHNICAL FIELD

The present invention relates generally to communication networks. In particular, the present invention relates to a method and apparatus for integrating wireless telephone service with portable short-range communication devices.

### BACKGROUND OF THE INVENTION

A wide variety of alternatives are available for enhancing home or office telephone systems. For example, restrictions on mobility arising from the inadequate length of telephone cords have been surmounted through the introduction the cordless telephone. This facilitates a user to increase roaming range, which can be extended to a virtually unlimited extent through the additional purchase of a cellular telephone. However, the range limitations of cordless telephones created an incentive to have a cordless telephone for home use and a cellular telephone for use outside of the home.

A cordless telephone system typically includes a portable cordless handset and a cordless base station connected to a telephone company phone system by telephone landlines. The cordless base station has an assigned landline telephone number that allows the user to place and receive calls using the cordless portable handset within a limited range of the cordless base station, such as in a home.

As mentioned above, wireless communication outside of the range of the cordless telephone system may also be provided via a cellular telephone system. A cellular telephone system typically includes portable subscriber stations and cellular base stations connected to the landline telephone system by way of one or more cellular switching networks. Each cellular subscriber unit has an assigned cellular telephone number that allows calls to be made and received throughout the area covered by base stations operated by the applicable service provider and its affiliated providers.

It has been found that difficulties tend to arise when a user frequently relocates between the nominal domains of the cordless and cellular telephone systems. For example, incoming calls routed through the cellular system may be missed when the user is at home, and incoming calls routed to the user's landline telephone number may be missed when the user is outside of the home.

Efforts to address these difficulties have been directed to the development of handsets capable of operating as standard cellular radiotelephones and also as cordless (or microcellular) telephones when within range of an associated cordless (or microcellular) base station. For example, a cordless communication system incorporating a portable cellular cordless (“PCC”) radiotelephone has been described. The PCC has the ability to communicate with a conventional cellular radiotelephone system, with a microcellular base station, or a cordless base station. The cordless communication system uses authorization and call routing equipment to provide call routing information to a telephone switching system disposed to automatically route calls between the cellular, microcellular, and cordless systems. In addition, a system has been described in which handsets automatically switch between a standard cellular telephone radiotelephone mode of operation and an enhanced cordless mode when within range of picocells located at customer-selected locations. Unfortunately, implementation of such “dual-mode” systems may often be impractical due to the relatively high cost of dual-mode handsets and the increased system complexity arising from the addition of specialized call routing equipment to switch between landlines and cellular telephone “lines.”

Another proposal to facilitate integration of wireless (e.g., cellular or PCS) and landline communication networks involves utilization of a subscriber personal base station to originate a call to the wireless network when the subscriber's cellular/PCS device is within range of the of the personal base station. Such proposals contemplate that the call originated by the personal base station results in the wireless network being instructed to route all cellular/PCS calls to the subscriber's landline phone number when the cellular/PCS device is detected as being within range of the personal base station. Specifically, the call originated by the personal base station is directed to a new network element at a mobile switching center that answers the call, collects the necessary information, emulates a visitors location register (“VLR”) and originates a registration notification to a subscribers home location register (“HLR”). When registered, the call will result in the HLR querying the new network element or special VLR for re-routing information on all subsequent calls made to the subscriber's cellular number. The special VLR will respond to the HLR by re-routing such subsequent calls to the subscriber's landline telephone number.

One disadvantage of the foregoing proposal is the requirement that a user generally possess at least a personal base station, a landline telephone and a cellular telephone. If the user does not desire to, for example, continue to posses a landline telephone upon acquiring a personal base station, then when the user leaves the location that would otherwise be served by the landline telephone (e.g., the user's home) such location is left without telephone service. Accordingly, the user is required to purchase all three of the devices listed above, including landline and wireless subscription service, or accept the consequences of having only intermittent phone service available at home or office locations. Moreover, the personal base stations currently being considered for development in connection with the foregoing proposal generally utilize a wireless communication link to obtain identification information concerning the subscriber's cellular/PCS device when such device is determined to be within radio range of the personal base station. This results in appreciable increases in complexity and cost, since the personal base station is required to incorporate a dedicated radio transceiver simply for detecting and/or obtaining information from the subscriber's cellular/PCS device.

Thus there exists a need for a system capable of further improving integrated wireless and landline telephone service in a cost effective manner, and which preferably eliminates the need for acquisition of a separate landline telephone service, personal base station, and wireless service.

In view of the foregoing, there is a need to provide a method and apparatus that permits existing wireless telephones to be engaged to route incoming and outgoing calls to and from a portable unit without the use of a landline service.

### SUMMARY OF THE INVENTION

The present invention eliminates the above-mentioned needs for wireless telephones to be engaged to route incoming and outgoing calls to and from a portable unit without the use of a landline service by providing a method for communicating over a wireless communications network and a communications docking station for wireless communication devices.

In accordance with the present invention, there is provided a method for communicating over a wireless communications network, the method comprising the steps of providing a docking port of a base member for a wireless communication device, linking the wireless communication device to a communications system of the base member, engaging a base unit of the communications system to perform a function, converting the function into output data, transmitting the output data to the communications system, routing the output data from the communications system to the wireless communication device, and communicating the output data from the wireless communication device to the wireless communications network.

The present invention is additionally directed to a communications docking station for wireless communication devices comprising a base member, a communications system coupled to the base member, at least one wireless device docking port connected to the base member, and a communications unit linking the communications system to the at least one wireless docking port.

### BRIEF DESCRIPTION OF THE FIGURES

FIGURE 1 is a perspective view of the preferred embodiment of the present invention.

### DETAILED DESCRIPTION OF THE INVENTION

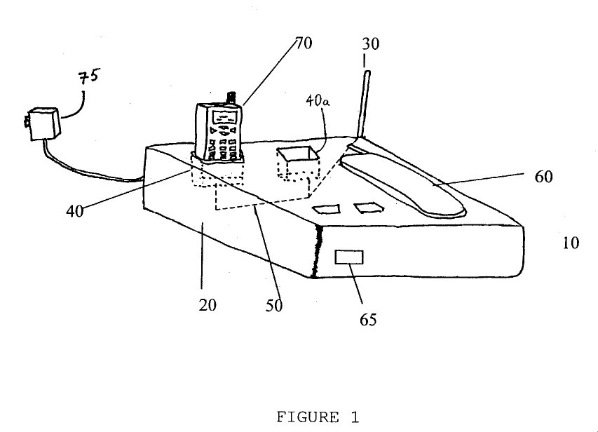

Referring now to FIGURE 1, a preferred embodiment of the present invention is illustrated as communications docking station 10. Communications docking station 10 for a wireless communication device comprises a base member 20, a communications system 30 coupled to base member 20 at least one wireless device docking port 40 connected to base member 20 and a communications unit 50 linking said communications system to said at least one wireless docking port.

Communications docking station 10 further comprises a base unit 60 detachably connected to base member 20. In operation, base unit 60 appears to and is engaged by a user much like a cordless telephone. Base unit 60 performs a function, such as transmitting output data in the form of a call to communications system 30, when engaged by a user. Communications system 30 routes the output data to a wireless communication device 70, such as a cellular telephone.

Wireless communication device 70 is operatively engaged or coupled to wireless docking port 40. Once the output data is routed from communications system 30 to wireless communication device 70, wireless communication device 70 communicates the output data to a wireless communications network (not shown).

As described below and in the accompanying Figure, one embodiment of the invention permits the cellular telephone user to insert his cellular telephone 70 into an adapter in a port (wireless docking port 40) of a base station (communications docking station 10). Cellular telephone 70 is left powered on, as base station 10 functions to recharge cellular telephone 70 as well. Incoming and outgoing calls to cellular telephone 70 are routed through cellular telephone 70 and base station 10 and received or transmitted, respectively, by a portable unit 60 resembling a cordless telephone. This allows users to be anywhere in a home, office, hotel, or other location and employ their cellular “line” without incurring landline charges, subjecting themselves to electromagnetic radiation, or depleting the batteries of cellular telephone 70.

As stated above, communications docking station 10 for wireless communication devices is shown comprising a base member 20, a communications system 30 coupled to base member 20, at least one wireless device docking port 40 connected to base member 20, and a communications unit 50 linking communications system 30 to at least one wireless docking port 40. An additional wireless docking port is shown in FIGURE 1 as wireless docking port 40a. The communications docking station can further include a base unit 60 detachably connected to the base member 20.

Base unit 60 transmits data (such as an electronic signal) to communications system 30, so as to appear functionally similar to a traditional landline-based cordless telephone. Communications system 30 then routes the data to a wireless communication device 70, which is operatively engaged to wireless docking port 40 (or additional wireless docking port 40a). Wireless communication device 70 then communicates the data to a wireless communications network, thereby eliminating the need for a landline.

In practicing the method of the preferred embodiment, the method for communicating over a wireless communications network includes the steps of providing docking port 40 of base member 20 for wireless communication device 70, linking wireless communication device 70 to communications system 30 of base member 20, engaging base unit 60 of communications system 30 to perform a function, converting the function into output data, transmitting the output data to communications system 30, routing the output data from communications system 30 to wireless communication device 70, and communicating the output data from wireless communication device 70 to a wireless communications network.

The method further comprises the steps of receiving input data from the wireless communications network to wireless communication device 70, routing the input data from wireless communication device 70 to communications system 30, transmitting the input data from communications system 30 to base unit 60, converting the input data into user data, and communicating the user data to a user.

Wireless communication device 70 can be any wireless device, including personal digital assistants, computers, pagers, and wireless telephones. Preferably, wireless communication device 70 is a wireless telephone.

Moreover, base member 20 is capable of recharging wireless communication device 70 and can be connected to a power source via an adapter, such as adapter 75, to perform the recharging function.

Additionally, base unit 60 is portable, thereby facilitating ease of use and mobility within a range. In the alternative embodiment, base unit 65 is affixed to base member 20. Base unit 65 may be a receiver, such as a radio signal receiver/transmitter or an infrared receiver/transmitter, thus permitting additional access to the wireless network, including but not limited to computer networks, such as the Internet.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. A method for communicating over a wireless communications network, said method comprising the steps of:
providing a docking port of a base member for a wireless communication device;
linking said wireless communication device to a communications system of said base member;
engaging a base unit of said communications system to perform a function;
converting said function into output data;
transmitting said output data to said communications system;
routing said output data from said communications system to said wireless communication device; and
communicating said output data from said wireless communication device to said wireless communications network.

2. The method according to claim 1 further comprising the steps of:
receiving input data from said wireless communications network to said wireless communication device;
routing said input data from said wireless communication device to said communications system;
transmitting said input data from said communications system to said base unit; converting said input data into user data; and
communicating said user data to a user.

3. The method according to claim 1 wherein said wireless communication device is a wireless telephone.

4. The method according to claim 1 wherein said base member recharges said wireless communication device.

5. The method according to claim 1 wherein said base member is connected to a power source.

6. The method according to claim 1 wherein said base unit is portable.

7. The method according to claim 1 wherein said base unit is affixed to said base member.

8. The method according to claim 1 wherein said output data is transmitted over a radio frequency.

9. A communications docking station for wireless communication devices comprising:
a base member;
a communications system coupled to said base member;
at least one wireless device docking port connected to said base member; and
a communications unit linking said communications system to said at least one wireless docking port.

10. The communications docking station according to claim 9 further comprising a base unit detachably connected to said base member.

11. The communications docking station according to claim 10 wherein said base unit performs a function.

12. The communications docking station according to claim 11 wherein said base unit transmits output data to said communications system.

13. The communications docking station according to claim 12 wherein said communications system routes said output data to a wireless communication device.

14. The communications docking station according to claim 13 wherein said wireless communication device is operatively engaged to said wireless docking port.

15. The communications docking station according to claim 14 wherein said wireless communication device communicates said output data to a wireless communications network.
